(19) United States
(12) Patent Application Publication
(10) Pub. No.: US 2024/0295210 A1
(43) Pub. Date: Sep. 5, 2024

(54) A BLADE FOR A WIND TURBINE

(71) Applicant: Vestas Wind Systems A/S, Aarhus N (DK)

(72) Inventors: Rens Christiaan Verhoef, Ringkøbing (DK); Gurmukh Singh, Skjern (DK)

(21) Appl. No.: 18/572,234

(22) PCT Filed: Jun. 28, 2022
(86) PCT No.: PCT/DK2022/050150

§ 371 Date: Dec. 20, 2023

(30) Foreign Application Priority Data
Jun. 30, 2021 (DK) PA 2021 70344

(51) Int. Cl. F03D 1/06

(52) U.S. Cl. CPC F03D 1/0688; F03D 1/069; F05B 2240/303; F05B 2240/304

(57) ABSTRACT

The present disclosure provides a blade for a wind turbine, where the blade extends in a lengthwise direction between a root end and a tip end of the blade. The blade comprises a leeward shell portion and a windward shell portion, each extending in a chordwise direction between a leading edge of the blade and a trailing edge of the blade. A first windward reinforcement structure and a first leeward reinforcement structure are arranged internally within the blade and engage the windward and the leeward shell portion, respectively. The first windward and first leeward reinforcement structures extend in the lengthwise direction of the blade and have a thickness in the thickness direction of the blade. The respective thicknesses of the first leeward reinforcement structure and the first windward reinforcement structure decrease towards the tip end in the lengthwise direction in a first section of the blade; and at at least one position along the length of the blade, the decrease of the thickness of the first leeward reinforcement structure is staggered with respect to the decrease of the thickness of the first windward reinforcement structure.

### FIELD OF THE DISCLOSURE

The present disclosure relates to a wind turbine blade, and more specifically to a wind turbine blade comprising a plurality of reinforcement structures internally within the blade.

### BACKGROUND OF THE DISCLOSURE

Traditionally, wind turbine blades are made from an outer shell and an inner hollow elongate spar of generally rectangular cross section. The spar serves to transfer loads from the rotating blade to the hub of the wind turbine. Such loads include tensile and compressive loads directed along the length of the blade arising from the circular motion of the blade and loads arising from the wind which are directed along the thickness of the blade, i.e. from the windward side of the blade to the leeward side.

### DESCRIPTION OF THE DISCLOSURE

It is an object of embodiments of the disclosure to provide an improved wind turbine blade.

According to a first aspect, the disclosure provides a blade for a wind turbine, the blade extending in a lengthwise direction between a root end and a tip end of the blade, the blade comprising:
a leeward shell portion and a windward shell portion, each of the shell portions defining respective inner and outer surfaces extending in a chordwise direction between a leading edge of the blade and a trailing edge of the blade, wherein the blade extends in a thickness direction between the leeward shell portion and the windward shell portion;
a first windward reinforcement structure internally within the blade, the first windward reinforcement structure engaging the windward shell portion;
a first leeward reinforcement structure internally within the blade, the first leeward reinforcement structure engaging the leeward shell portion;
wherein:
the first windward and first leeward reinforcement structures extend in the lengthwise direction of the blade and have a thickness in the thickness direction of the blade;
the respective thicknesses of the first leeward reinforcement structure and the first windward reinforcement structure decrease towards the tip end in the lengthwise direction in a first section of the blade; and
at at least one position along the length of the blade, the decrease of the thickness of the first leeward reinforcement structure is staggered with respect to the decrease of the thickness of the first windward reinforcement structure.

The blade may be attached to a wind turbine which may comprise a plurality of blades, such as three blades which may be configured to interact with the passing air flow to produce lift that causes a hub to rotate about its longitudinal axis. Wind speed in excess of a minimum level may activate the rotor and allow it to rotate within a plane substantially perpendicular to the direction of the wind. The rotation can be converted to electric power by a generator and is usually supplied to the utility grid.

The blade extends in a lengthwise direction between a root end and a tip end of the blade, where the root end may be configured for attachment to the hub.

The blade comprises a leeward shell portion and a windward shell portion, where each of the shell portions defining respective inner and outer surfaces extend in a chordwise direction between a leading edge of the blade and a trailing edge of the blade. The inner surface of the leeward shell portion may face the inner surface of the windward shell portion. A hollow blade may be defined by the two shell portions.

The leeward shell portion and the windward shell portion may be adhesively bonded at the leading edge and the trailing edge. Alternatively, the blade may be manufactured in a ‘single shot’ process where the leeward shell portion and the windward shell portion are integrally formed.

The blade extends in a thickness direction between the leeward shell portion and the windward shell portion, where the thickness may vary both along the lengthwise direction of the blade and along the chordwise direction.

To increase the strength of the blade, the blade comprises a first windward reinforcement structure internally within the blade, wherein the first windward reinforcement structure engages the windward shell portion. Additionally, the blade comprises a first leeward reinforcement structure internally within the blade, where the first leeward reinforcement structure engages the leeward shell portion.

In one embodiment, the blade may be made using a vacuum assisted resin-infusion process by use of a mould for each of the windward and leeward shell portions, respectively. A glass-fibre layer may be arranged in the mould to form the outer skin of the blade. A plurality of panels of foam or balsa may be arranged on top of the glass-fibre layer to form a sandwich panel core. The sandwich panels may be spaced apart relative to one another to define a channel in between in the lengthwise direction of the blade. The first windward reinforcement structure and the first leeward reinforcement structure may each be arranged in a channel in each of the windward and leeward shell portions.

After positioning of the first windward and first leeward reinforcement structures, a second glass-fibre layer may be arranged on top of the sandwich panels and the reinforcement structures. The second glass-fibre layer may form an inner skin of the blade.

By use of vacuum, resin may be supplied to each of the moulds. The resin may infuse between the various laminate layers and may fill any gaps in the laminate layup. Once sufficient resin has been supplied to the mould, the mould may be heated whilst the vacuum is maintained to cure the resin and bond the various layers together to form the windward and leeward shell portions of the blade. An adhesive may be applied along the leading and trailing edges of the shell portions and the shell portions are bonded together to form the complete blade.

It should be understood that the above description is of one embodiment, and that the blade may alternatively be formed by another process. As an example, the first windward reinforcement structure and the first leeward reinforcement structure may each be formed as a separate element which may subsequently be attached to the windward shell portion and the leeward shell portion, such as an inner surface hereof, respectively.

The first windward and first leeward reinforcement structures extend in the lengthwise direction of the blade and have a thickness in the thickness direction of the blade. The first windward and the first leeward reinforcement structures may form a pair and may be arranged so that they substantially face each other when the shell portions are assembled to form the complete blade. Thus, the first windward and first leeward reinforcement structures may be arranged substantially opposite to each other when the blade is assembled.

By arranged substantially opposite to each other, should be understood, that a projection of the first windward reinforcement structure and a projection of the first leeward reinforcement on a plane extending between the leading edge and the trailing edge may overlap each other at least 80% , such as 90% , such as 95% in a cross-section in the chordwise direction.

To further reinforce the blade, a first shear web extending in the lengthwise direction of the blade may bridge the first windward and the first leeward reinforcement structures. The first shear web may in combination with the first windward and the first leeward reinforcement structures form an I-beam structure, also called a spar structure where the first windward and the first leeward reinforcement structures form the spar caps. The I-beam structure/the spar structure may transfer loads effectively from the rotating blade to the hub of the wind turbine. The first windward and the first leeward reinforcement structures may in particular transfer tensile and compressive bending loads, whilst the first shear web may transfer shear stresses in the blade.

The respective thicknesses of the first leeward reinforcement structure and the first windward reinforcement structure decrease towards the tip end in the lengthwise direction in a first section of the blade. As the size of the blade may be smaller at the tip end than at the root end, the first section may be arranged within the outer half of the blade.

The decrease of the thickness of at least one of the first leeward and the first windward reinforcement structure may be a gradual decrease; i.e. the thickness may decrease over a distance. This may as an example be achieved by decreasing the thickness in steps or by continuously decreasing the thickness over a predetermined distance.

In should be understood that when decreasing the thickness in the first section of the blade, the first section may comprise at least one sub-section where the thickness is constant and at least one sub-section where the thickness decreases. In an embodiment, where the thickness decreases stepwise, the first section may comprise a plurality of sub-sections where the thickness is substantially constant and a plurality of sub-sections where the thickness decreases. It should further be understood that a sub-section where the thickness decreases may have a size in the lengthwise direction being less than 10 mm, less than 5 mm, or even less than 1 mm, when the step is substantially parallel to the thickness direction. In an alternative embodiment, the stepwise decrease of the thickness may comprise a plurality of tapered sub-sections and a plurality of intermediate sub-sections, where the thickness is constant; i.e. the thickness may decrease from a first thickness in a first intermediate sub-section to a second thickness in a second intermediate sub-section, the decrease of the thickness being performed in a tapered sub-section arranged between the first intermediate sub-section and the second intermediate sub-section.

The first windward reinforcement structure and the first leeward reinforcement structure may each be formed by a plurality of layers, whereby the decrease of the thickness of the first windward and first leeward reinforcement structures may be achieved by terminating the layers at different positions along the blade in the lengthwise direction. The termination of a layer may be a cut substantially perpendicular to the lengthwise direction. Alternatively, a layer may be terminated by a tapered section, e.g. with a taper ratio in the range of 1:100.

In one embodiment, the first windward and the first leeward reinforcement structures may be formed by layers of pultruded elements, such as pultruded strips of composite material, which may be carbon-fibre reinforced plastic. The thickness of each layer may be in the range of 3-10 mm, such as 4-8 mm. An advantage of a thickness of each layer in this range may be that the pultruded strips may be supplied in a roll.

At least at one position along the length of the blade, the decrease of the thickness of the first leeward reinforcement structure is staggered with respect to the decrease of the thickness of the first windward reinforcement structure. By staggering the decrease of the thicknesses, a change of the distance between the first leeward reinforcement structure and the first windward reinforcement structure in the thickness direction may be reduced, whereby shear stress may be reduced.

The first leeward reinforcement structure and the first windward reinforcement structure may be bridged by a first shear web to thereby form a spar structure. The height of the spar (in the thickness direction) decreases from a root end of the blade to a tip end of the blade, as the blade tapers in thickness from the root end to the tip end. In such a tapered spar the first leeward reinforcement structure and the first windward reinforcement structure are non-parallel and are inclined at an angle to each other. Such a tapered spar is beneficial as shear forces in the web are reduced (compared to a prismatic spar) as component of the load in the angled reinforcement structure resist the shear forces in the web.

As the thickness of the blade and the spar reduces toward the tip end of the blade, the respective thicknesses of the first leeward and windward reinforcement structures may also decrease towards the tip end in the lengthwise direction in a first section of the blade.

However, as the thickness of each of the first leeward and first windward reinforcement structures may be reduced in steps; in particular when forming the first leeward and first windward reinforcement structures as layered structures, the distance between the first leeward and first windward reinforcement structures may actually increase in the first section of the blade if the reduction of thickness is not carefully controlled. By staggering the decrease in thickness, it can be ensured that the distance between the first leeward and first windward reinforcement structures continues to decrease towards the tip end or at least that any increase in distance is minimised. This reduces the shear forces in the web and in a bond line between the first shear web and the first leeward and first windward reinforcement structures compared to a non-staggered arrangement. The reduction in shear forces leads to a more robust spar structure and can also lead to less material being used and hence a reduced mass.

The thickness of the first leeward reinforcement structure and of the first windward reinforcement structure decreases in the first section of the blade, which first section may extend at least 25 percent of the length of the blade in the lengthwise direction.

It should be understood that the thickness of one of the first leeward and first windward reinforcement structures may decrease along a longer section in the lengthwise direction than the other one of the first leeward and first windward reinforcement structures. As an example, the thickness of the leeward reinforcement structure may in one embodiment decrease in a section being up to 40% of the length of the blade, whereas the thickness of the windward reinforcement structure may decrease in a section being up to 30% of the length of the blade. This may be particularly relevant, if the thickness of the first leeward reinforcement structure is larger than the thickness of the first windward reinforcement structure.

In one embodiment, the decrease of the thickness of the first leeward reinforcement structure may be staggered with respect to the decrease of the thickness of the first windward reinforcement structure at a plurality of positions in the first section which may be at least 25% of the length. The number of positions at which the decrease of the thickness is staggered may be in the range of 4-15, such as 6-12. The number of positions at which the decrease is staggered may depend on the size of the blade, such as the length of the blade.

The decrease of the thickness of the first leeward reinforcement structure and the first windward reinforcement structure may be achieved by termination of one of more layers forming or forming part of the first leeward and the first windward reinforcement structures in the lengthwise direction of the blade. When a layer is terminated, the number of layers continuing in the lengthwise direction of the blade is reduced, whereby the thickness may be decreased.

A termination of one layer may e.g. be carried out by cutting a layer. When cutting or otherwise terminating a layer, the terminated end may be chamfered. In one embodiment, one or more of the layers may be chamfered at both ends. Chamfered layers may facilitate stress transfer from one layer to an adjacent layer.

The decrease may be formed as a stepwise decrease, e.g. by terminating one or more layers at different positions within the first section in the lengthwise direction as described above. Thus, the thicknesses of the first windward and the first leeward reinforcement structures may decrease in steps, where each step may have a length in the lengthwise direction in the range of 0.3-0.8 meters. The length of the steps may depend on the size of the blade, such as of the length of the blade. In one embodiment, all steps of the first windward and/or the first leeward reinforcement structure may be of the same length. However, in an alternative embodiment the length of at least some of the steps may vary, e.g. in sections along the length of the blade. The length of the steps may in one embodiment be longer closer to the tip end of the first section, as the shear forces are smaller closer to the tip end, where the thickness of the blade is smaller.

When staggering the decrease of the thickness, a step of the first windward reinforcement structure and a step of the first leeward reinforcement structure may be mutually displaced by a distance in the range of 0.1-0.7 meters. i.e. a distance between a position where the thickness of the first windward reinforcement structure is decreased and a position where the thickness of the first leeward reinforcement structure is decreased may be in the range of 0.1-0.7 m. This distance may in one embodiment be uniform and in an alternative embodiment be non-uniform. The distance may be dependent on the size of the blade, such as the length of the blade.

The thickness may decrease in steps where multiple steps of the first windward and the first leeward reinforcement structures may be mutually staggered.

At least at one position along the length of the blade, the thickness of the first leeward reinforcement structure may be equal to the thickness of the first windward reinforcement structure along a range of lengthwise overlap between respective steps of the first leeward and first windward reinforcement structures. In these overlapping sections, where the thickness of the first leeward reinforcement structure is equal to the thickness of the first windward reinforcement structure, the distance between the reinforcement structures is substantially constant, which may ensure that shear forces are not increased. The lengthwise overlap may be of equal length or may vary, e.g. in sections.

An equal thickness may as an example be achieved by providing the first leeward reinforcement structure and the first windward reinforcement structure as layered structures, where the number of layers is equal at the lengthwise overlaps. In one embodiment, the layers may be of different thickness, whereby an equal thickness may be achieved by an uneven number of layers.

Since the blade is more heavily loaded in compression on the leeward side, the thickness of the first leeward reinforcement structure may be larger than the thickness of the first windward reinforcement structure at a second section of the blade in the lengthwise direction, where the second section may be closer to the root end than the first section. This may increase the resistance towards strain of the first leeward reinforcement structure. When the first leeward reinforcement structure and the first windward reinforcement structure are made of carbon-fibre reinforced plastic, a larger thickness of the first leeward reinforcement structure may further compensate for the choice of material, as carbon does not perform as well in compression as compared to tension.

In the second section, the thickness of the windward reinforcement structure may be substantially uniform at least along the major part of the second section. In an alternative embodiment, the thickness of the windward reinforcement structure may vary along the second section, while being smaller than the leeward reinforcement structure.

The thickness of the leeward reinforcement structure may likewise be substantially uniform at least along the major part of the second section. In an alternative embodiment, the thickness of the leeward reinforcement structure may vary along the second section, while being larger than the first windward reinforcement structure.

In one embodiment, the thickness of the first leeward reinforcement structure may increase along a first part of the second section, where the first part is closer to the root end, e.g. by increasing the number of layers of the layered structure forming the first leeward reinforcement structure. By increasing the thickness in steps, the impact of stress which could arise due to increased thickness can be reduced. Additionally or alternatively, the thickness of the first leeward reinforcement structure may decrease along a second part of the second structure, where the second part is closer to the tip end, e.g. by decreasing the number of layers of the layered structure forming the first leeward reinforcement structure. By decreasing the thickness in steps, the distance between the first leeward and first windward reinforcement structures continues to decrease towards the tip end or at least any increase in distance is minimised, whereby the shear forces in the web and in a bond line between the web and the first leeward and first windward reinforcement is reduced. The second section may comprise an additional section in which the thickness of the leeward reinforcement section maybe substantially constant.

It should be understood that the second section and the first section may overlap each other in the lengthwise direction of the blade, whereby the thickness of the first leeward reinforcement structure may be larger in the overlap section while the decrease of the thickness of the first leeward reinforcement structure may also be staggered with respect to the decrease of the thickness of the first windward reinforcement structure in the overlap section. Thus, the thicknesses of the first windward and the first leeward reinforcement structures may decrease in at least a part of the second section of the blade.

In one embodiment, the second section, in which the thickness of the first leeward reinforcement structure may be larger than the thickness of the first windward reinforcement structure, may constitute at least one third of the length of the blade in the lengthwise direction. The length may depend on the size of the blade, such as on the length of the blade.

The first leeward and the first windward reinforcement structures may be of substantially the same thickness in the lengthwise direction of the blade from a starting position of the reinforcement structures within a root section of the blade, where the root section is a section in the lengthwise direction starting at the root end of the blade and extending in the lengthwise direction of the blade. The starting position is at a distance from the root end within the root section.

To increase the strength of the blade at the trailing edge, the blade may further comprise a second windward reinforcement structure internally within the blade and a second leeward reinforcement structure internally within the blade, the second windward reinforcement structure engaging the windward shell portion and the second leeward reinforcement structure engaging the leeward shell portion, the second windward and second leeward reinforcement structures extending in the lengthwise direction and being arranged closer to the trailing edge than the first windward reinforcement structure and the first leeward reinforcement structure, respectively, wherein the second windward reinforcement structure is longer than the second leeward reinforcement structure in the lengthwise direction.

Particularly, the second leeward and second windward reinforcement structures may be provided to prevent the buckling at the trailing edge.

At the tip end where the thickness of the blade is smaller, the need for reinforcement may be decreased. Reinforcement of the trailing edge at the tip end of the blade may be facilitated by arranging a reinforcement structure only at the windward shell being curved compared to the leeward shell as performance towards buckling is better at a curved surface. This may be achieved by providing a second windward reinforcement structure being longer than a second leeward reinforcement structure in the lengthwise direction.

The second leeward and second windward reinforcement structures may be formed as a layered structure, e.g. formed by a plurality of pultruded strips of composite material, such as carbon-fibre reinforced plastic. Thus, a second windward reinforcement structure being longer than a second leeward reinforcement structure in the lengthwise direction may as an example be achieved by terminating the layers forming the second leeward reinforcement structure without terminating all the layers forming the second windward reinforcement structure.

The starting positions of the first and second leeward and windward reinforcement structures may be approximately the same starting positions in the lengthwise direction, where the first leeward and first windward reinforcement structures may be arranged closer to the leading edge and the second leeward and second windward reinforcement structures may be arranged closer to the trailing edge.

Both the second leeward and second windward reinforcement structures may have a length being shorter than the first leeward and first windward reinforcement structures, as the width of the blade decreases towards the tip end of the blade. The length of the first leeward and first windward reinforcement structures may be substantially equal, in contradiction to the second leeward and second windward reinforcement structures where the second windward reinforcement structure may be longer than the second leeward reinforcement structure in the lengthwise direction as described above.

By providing the second windward reinforcement structure longer than the second leeward reinforcement structure in the lengthwise direction, the edgewise stiffness of the tip end of the blade may be increased at the trailing edge, whereby buckling of the trailing edge may be prevented while also using the material more effectively by placing it at the windward side.

### BRIEF DESCRIPTION OF THE DRAWINGS

Embodiments of the disclosure will now be further described with reference to the drawings, in which:

FIG. 1 illustrates the main structural components of a wind turbine;

FIGS. 2A and 2B illustrate two different cross-sections through an embodiment of a wind turbine blade;

FIG. 3 schematically illustrates the thickness of a first windward reinforcement structure and a first leeward reinforcement structure along the lengthwise direction of a blade;

FIG. 4 schematically illustrates the staggered decrease of the respective thicknesses of a first windward reinforcement structure and a first leeward reinforcement structure at the tip end of a blade;

FIG. 5 schematically illustrates different distances between a first windward reinforcement structure and a first leeward reinforcement structure in a cross-section; and

FIG. 6 illustrates a windward shell portion with first and second windward reinforcement structures and a leeward shell portion with first and second leeward reinforcement structures.

### DETAILED DESCRIPTION OF THE DRAWINGS

It should be understood that the detailed description and specific examples, while indicating embodiments of the disclosure, are given by way of illustration only, since various changes and modifications within the spirit and scope of the disclosure will become apparent to those skilled in the art from this detailed description.

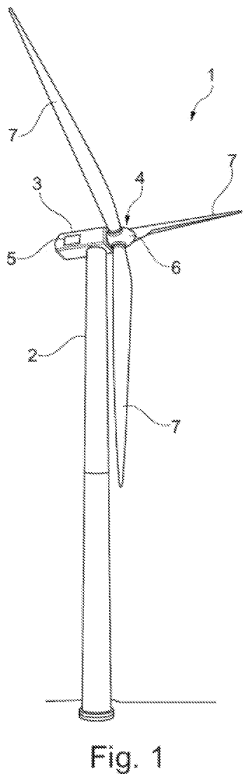

FIG. 1 illustrates a typical wind turbine 1 comprising a tower 2, a nacelle 3 mounted at top of the tower 2 and a rotor 4 operatively coupled to a generator 5 within the nacelle 3. The wind turbine 1 converts kinetic energy of the wind into electrical energy. In addition to the generator 5, the nacelle 3 houses the various components required to convert the wind energy into electrical energy and also the various components required to operate and optimize the performance of the wind turbine 1. The tower 2 supports the load presented by the nacelle 3, the rotor 4, and other wind turbine components within the nacelle 3.

The rotor 4 includes a central hub 6 and three elongated blades 7 extending radially outward from the central hub 6. In operation, the blades 7 are configured to interact with the passing air flow to produce lift that causes the central hub 6 to rotate about its longitudinal axis. Wind speed in excess of a minimum level will activate the rotor 4 and allow it to rotate within a plane substantially perpendicular to the direction of the wind. The rotation is converted to electric power by the generator 5 and is usually supplied to the utility grid.

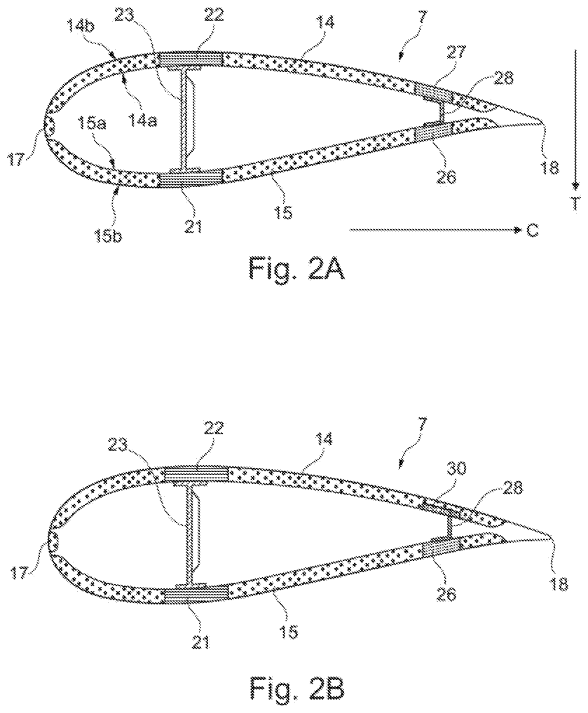

FIGS. 2A and 2B illustrate two different cross-sections through an embodiment of a wind turbine blade 7.

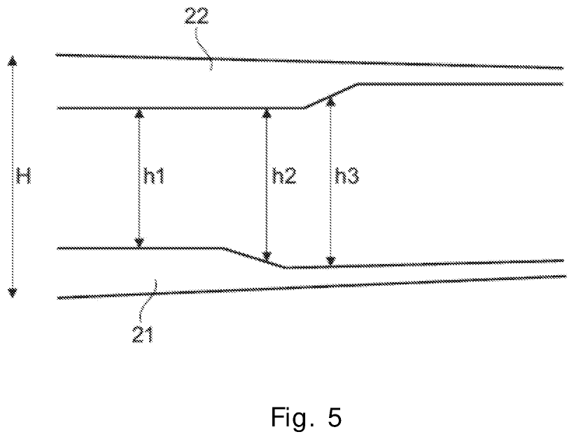

The blade 7 extends in a lengthwise direction L (see FIG. 5) between a root end 10 and a tip end 12 of the blade, where the root end 10 (see FIG. 5) is configured for attachment to the hub.

The blade 7 comprises a leeward shell portion 14 and a windward shell portion 15, where each of the shell portions 14, 15 defines respective inner 14a, 15a and outer surfaces 14b, 15b extending in a chordwise direction C between a leading edge 17 of the blade and a trailing edge 18 of the blade. The inner surface 14a of the leeward shell portion 14 faces the inner surface 15a of the windward shell portion 14, whereby a hollow blade is defined by the two shell portions 14, 15.

The blade 7 extends in a thickness direction T between the leeward shell portion 14 and the windward shell portion 15.

The blade 7 comprises a first windward reinforcement structure 21 internally within the blade 7, where the first windward reinforcement structure 21 engages the windward shell portion 15. Additionally, the blade 7 comprises a first leeward reinforcement structure internally 22 within the blade 7, where the first leeward reinforcement structure 22 engages the leeward shell portion 14.

The first windward and first leeward reinforcement structures 21, 22 extend in the lengthwise direction L of the blade 7 (see FIG. 5) and have a thickness in the thickness direction T of the blade. The first windward and the first leeward reinforcement structures 21, 22 form a pair and are arranged so that they face each other when the shell portions 14, 15 are assembled to form the complete blade 7.

A first shear web 23 extends in the lengthwise direction L of the blade 7 and bridges the first windward and the first leeward reinforcement structures 21, 22. As illustrated, the first shear web 23 in combination with the first windward and the first leeward reinforcement structures 21, 22 form an I-beam structure/a spar structure which may transfer loads effectively from the rotating blade 7 to the hub 6 (see FIG. 1) of the wind turbine.

The blade 7 may further comprise a second windward reinforcement structure 26 and a second leeward reinforcement structure 27 internally within the blade, where the second windward reinforcement structure 26 engages the windward shell portion 15 and the second leeward reinforcement structure 27 engages the leeward shell portion 14. The second windward and second leeward reinforcement structures 26, 27 extend in the lengthwise direction L and are arranged closer to the trailing edge 18 than the first windward reinforcement structure 21 and the first leeward reinforcement structure 22, respectively (see FIG. 5).

The second windward reinforcement structure 26 may be longer than the second leeward reinforcement structure 27 in the lengthwise direction, which is illustrated in FIG. 5. It is additionally illustrated by the difference between FIG. 2A and FIG. 2B, where the cross-section illustrated in FIG. 2A is closer to the root end 10 than the cross-section illustrated in FIG. 2B. The longer second windward reinforcement structure 26 is illustrated in both FIG. 2A and FIG. 2B, whereas the shorter second leeward reinforcement structure 27 is only illustrated in FIG. 2A.

A second shear web 28 may extend in the lengthwise direction L of the blade 7 and bridges the second windward and the second leeward reinforcement structures 26, 27.

As illustrated in FIG. 2B, the blade 7 may comprise an additional leeward reinforcement structure 30 which is arranged in continuation of the second leeward reinforcement structure 27 in the lengthwise direction L.

Each of the first and second leeward and first and second windward reinforcement structures 22, 27, 21, 26 may be formed as a layered structure of a plurality of pultruded strips of carbon-fibre reinforced plastic. The additional leeward reinforcement structure 30 may comprise glass fibres.

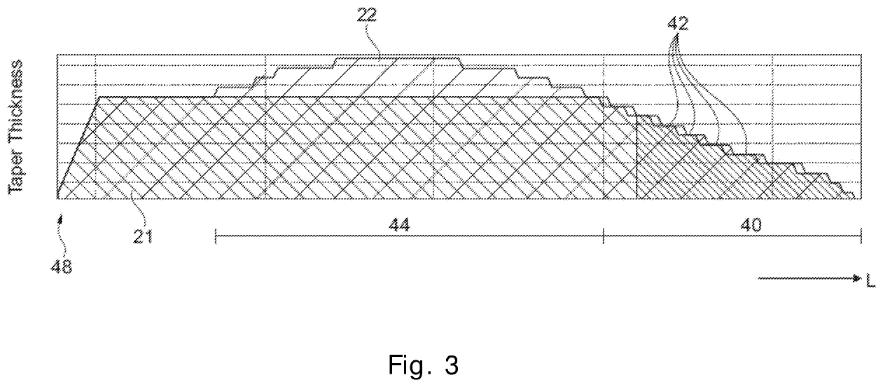

FIG. 3 illustrates a comparison between the thickness of a first windward reinforcement structure 21 and the thickness of a first leeward reinforcement structure 22 along the lengthwise direction L of a blade 7.

The respective thicknesses of the first leeward reinforcement structure 22 and the first windward reinforcement structure 21 decrease towards the tip end 12 in the lengthwise direction in a first section 40 of the blade 7.

The decrease of the thickness of the first windward and first leeward reinforcement structures 21, 22 is achieved by terminating the layers forming the reinforcement structures 21, 22 at different positions in the lengthwise direction L.

As illustrated in FIG. 3, the decrease of the thickness of the first leeward reinforcement structure 22 is staggered with respect to the decrease of the thickness of the first windward reinforcement structure 21 at a plurality of positions along the length of the blade 7.

At a plurality of positions along the length of the blade 7, the thickness of the first leeward reinforcement structure 22 is equal to the thickness of the first windward reinforcement structure 21 along a range of lengthwise overlap 42 between respective steps of the first leeward and first windward reinforcement structures 22, 21.

The thickness of the first leeward reinforcement structure 22 is larger than the thickness of the first windward reinforcement structure 21 at a second section 44 of the blade 7 in the lengthwise direction L, where the second section 44 is closer to the root end 10 than the first section 40.

In the illustrated embodiment, the thickness of the windward reinforcement structure 21 is substantially uniform along the second section 44.

In the illustrated embodiment, the thickness of the leeward reinforcement structure 22 increases in a first part of the second section 44, is uniform in a middle part of the second section 44, and decreases in a second part of the second section 44.

The first leeward and the first windward reinforcement structures 22, 21 are of substantially the same thickness in the lengthwise direction L of the blade 7 from a starting position 48 of the reinforcement structures towards the second section of the blade 7.

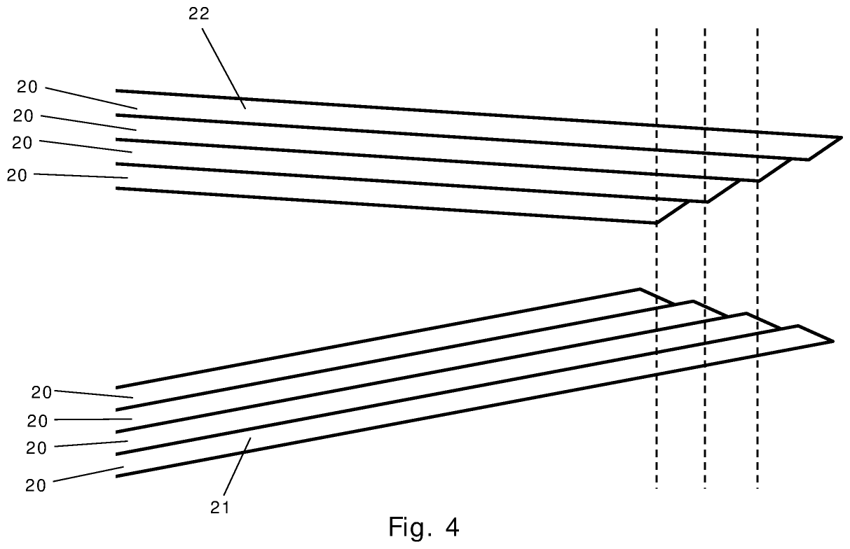

FIG. 4 schematically illustrates the staggered decrease of the respective thicknesses of a first windward reinforcement structure 21 and a first leeward reinforcement structure 22 at the tip end of a blade.

The first leeward reinforcement structure 22 and the first windward reinforcement structure 21 are non-parallel and are inclined at an angle to each other, as the height (in the thickness direction) of the spar formed by the first leeward reinforcement structure 22 and the first windward reinforcement structure 21 and the first shear web (not shown in FIG. 4) decreases from a root end of the blade to a tip end of the blade, as the blade tapers in thickness from the root end to the tip end.

In the illustrated embodiment, the decrease of the thickness of the first windward and first leeward reinforcement structures 21, 22 is achieved by terminating each of the layers 20 forming the reinforcement structures 21, 22 at different positions in the lengthwise direction L. The different positions are illustrated by the three vertical dotted lines.

The decrease of the respective thicknesses of the first leeward reinforcement structure 22 is staggered with respect to the decrease of the thickness of the first windward reinforcement structure 21 at a plurality of positions along the length of the blade. Termination of a layer 20 of the first leeward reinforcement structure 22 is marked by a vertical dotted line. The staggering can be seen as the vertical dotted line does not intersect a position where a layer 20 of the first windward reinforcement structure 21 is terminated.

FIG. 5 schematically illustrates different distances h between a first windward reinforcement structure 21 and a first leeward reinforcement structure 22 in a cross-section.

As the decrease of the thickness of the first leeward reinforcement structure 22 is staggered with respect to the decrease of the thickness of the first windward reinforcement structure 21 at a plurality of positions along the length of the blade 7, the change of the distance h1, h2, h3, between the first leeward reinforcement structure 22 and the first windward reinforcement structure 21 in the thickness direction is reduced, whereby shear stress in the web and in the bond line between the web and the spars may be reduced.

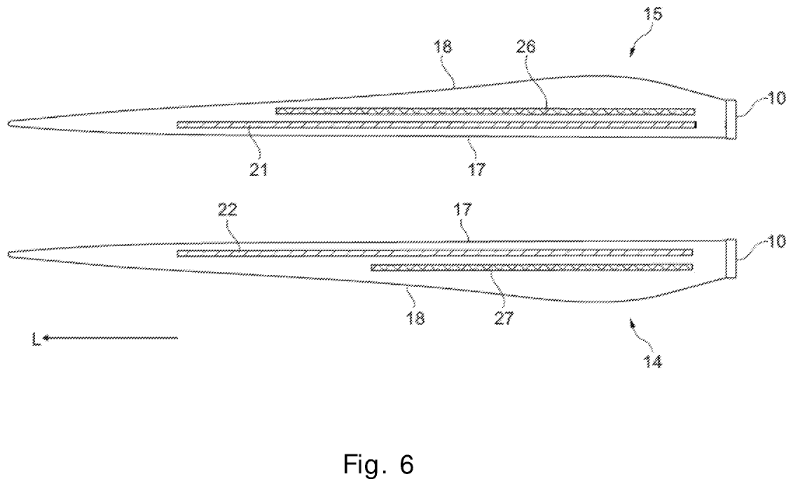

FIG. 6 illustrates a windward shell portion 15 with first and second windward reinforcement structures 21, 26 and a leeward shell portion 14 with first and second leeward reinforcement structures 22, 27. The first and second windward reinforcement structures 21, 26 may be arranged substantially in parallel. Likewise, may the first and second leeward reinforcement structures 22, 27 be arranged substantially in parallel.

The first windward and first leeward reinforcement structures 21, 22 may be of substantially the same length, whereas the second windward reinforcement structure 26 may be longer than the second leeward reinforcement structure 27.

1. A blade for a wind turbine, the blade extending in a lengthwise direction between a root end and a tip end of the blade, the blade comprising:
a leeward shell portion and a windward shell portion, each of the shell portions defining respective inner and outer surfaces extending in a chordwise direction between a leading edge of the blade and a trailing edge of the blade, wherein the blade extends in a thickness direction between the leeward shell portion and the windward shell portion;
a first windward reinforcement structure internally within the blade, the first windward reinforcement structure engaging the windward shell portion;
a first leeward reinforcement structure internally within the blade, the first leeward reinforcement structure engaging the leeward shell portion;
wherein:
the first windward and first leeward reinforcement structures extend in the lengthwise direction of the blade and have a thickness in the thickness direction of the blade;
the respective thicknesses of the first leeward reinforcement structure and the first windward reinforcement structure decrease towards the tip end in the lengthwise direction in a first section of the blade; and
at at least one position along the length of the blade, the decrease of the thickness of the first leeward reinforcement structure is staggered with respect to the decrease of the thickness of the first windward reinforcement structure.

2. The blade according to claim 1, wherein the first section of the blade extends at least 25 percent of the length of the blade in the lengthwise direction.

3. The blade according to claim 1, wherein the first windward reinforcement structure and the first leeward reinforcement structure are formed by a plurality of layers.

4. The blade according to claim 1, wherein the first windward and the first leeward reinforcement structures are formed by layers of pultruded elements.

5. The blade according to claim 1, wherein the thicknesses of the first windward and the first leeward reinforcement structures decrease in steps.

6. The blade according to claim 5, wherein a step of the first windward reinforcement structure and a step of the first leeward reinforcement structure are mutually displaced.

7. The blade according to claim 5, wherein multiple steps of the first windward and the first leeward reinforcement structures are mutually staggered.

8. The blade according to claim 5, wherein, at at least one position along the length of the blade, the thickness of the first leeward reinforcement structure is equal to the thickness of the first windward reinforcement structure along a range of lengthwise overlap between respective steps of the first leeward and first windward reinforcement structures.

9. The blade according to claim 1, wherein the thickness of the first leeward reinforcement structure is larger than the thickness of the first windward reinforcement structure at a second section of the blade in the lengthwise direction, the second section being closer to the root end than the first section.

10. The blade according to claim 9, wherein the second section constitutes at least one third of the length of the blade in the lengthwise direction.

11. The blade according to claim 9, wherein the thicknesses of the first windward and the first leeward reinforcement structures decrease in at least a part of the second section of the blade.

12. The blade according to claim 1, further comprising a second windward reinforcement structure internally within the blade and a second leeward reinforcement structure internally within the blade, the second windward reinforcement structure engaging the windward shell portion and the second leeward reinforcement structure engaging the leeward shell portion, the second windward and second leeward reinforcement structures extending in the lengthwise direction and being arranged closer to the trailing edge than the first windward reinforcement structure and the first leeward reinforcement structure, respectively, wherein the second windward reinforcement structure is longer than the second leeward reinforcement structure in the lengthwise direction.
